(19) United States
(12) Patent Application Publication
(10) Pub. No.: US 2010/0283256 A1
(43) Pub. Date: Nov. 11, 2010

(54) OIL COOLED GENERATOR GROUP

(76) Inventor: Gianfranco Bianchi, Genova (IT)

Correspondence Address: ARENT FOX LLP, 1050 CONNECTICUT AVENUE, N.W., SUITE 400, WASHINGTON, DC, 20036, US

(21) Appl. No.: 12/810,293

(22) PCT Filed: Dec. 19, 2008
(86) PCT No.: PCT/IB2008/003561

§ 371 Date: Jul. 27, 2010

(30) Foreign Application Priority Data
Dec. 24, 2007 (IT) M12007A002428

(51) Int. Cl. H02K 7/18; H02K 9/19

(52) U.S. Cl. 290/1 A; 310/54

(57) ABSTRACT

The invention relates to an operating unit for nautical use, wherein an internal combustion engine drives an electric energy generator. According to the invention, the generator is cooled by oil in which the rotor and the stator are partly immersed: the spinning motion of the rotor drags the oil into the air gap, thus cooling the stator as well.

The present invention relates to operating units intended for, in particular but not limited to, pleasure navigation applications, wherein an internal combustion engine drives an electric energy generator.

Operating units of this kind are known in the art, and in recent times they have undergone important innovations provided by the present Applicant, which have been described in several patents and patent applications; by way of example, reference may be made in this regard to the first of these documents, i.e. European patent EP 1120556. In practice, these new operating units carry out several functions in an integrated manner in addition to producing electric energy; such functions may consist of seawater desalination, environmental conditioning, liquid pressurization, and so on.

In general, this multifunctional capability provides better overall engine efficiency while reducing the room taken up aboard, so that these units turn out to be particularly advantageous for nautical applications.

Within the frame of this state of the art, an operating unit is also known wherein air is cooled by a conditioning system and is then delivered to the alternator for cooling the electric windings thereof; this solution is described in the published international patent application number WO2004/054072 in the name of the present Applicant.

In this case, the internal combustion engine also drives, among other things, the compressor of a refrigerating system, the evaporator of which cools an air flow directed towards the electric windings of the alternator.

This solution allows the operating unit to be cooled autonomously, i.e. without exchanging heat with the outside environment, so that it can be housed in a sealed soundproof enclosure cooled by conditioned air coming from the evaporator: it proves therefore especially advantageous when the operating unit is also used for environmental conditioning purposes, since it is already provided with all those components (i.e. evaporator, compressor, etc.) that are required by such a system.

However, whenever air conditioning is not needed it may be useful to adopt different solutions for providing alternator cooling; in such a case, a simple cooling with air at ambient temperature (i.e. unconditioned air) may be insufficient, and an alternative system may thus be required.

U.S. Pat. No. 3,078,409 in the name of General Motors discloses an alternator fitted with a current rectifying system, which is cooled by oil sucked from a sump which, in motor vehicle applications, is the engine gearbox oil sump.

In this case, the oil is fed by a pump to a chamber located on the alternator head, where the rectifier is housed; when the oil reaches a preset level in the chamber, it flows out of it through a transfer port and arrives at a fixed field core which magnetizes the rotor polar expansions by induction.

The fixed field core is hollow axially for allowing oil to flow in; when the oil arrives at the opposite end of the axial cavity, the dragging action exerted by the rotor diffuses it radially towards the rotor and stator windings.

The above-described cooling system does not appear to be a technically valid solution.

First of all, in fact, it is not always possible to provide an oil accumulation chamber on the head, due to the limited space available or to the shape of the alternator.

Secondly, the path followed by the oil, which includes the axial cavity of the fixed core, the air gap between the latter and the rotor, which has a vaguely cup-like shape, and the channels provided in the rotor polar expansions, is quite a long and tortuous one, thus arousing much perplexity about its actual effectiveness in terms of oil circulation and hence of alternator cooling performance.

The present invention aims at improving this state of the art.

Its object is to provide a multifunctional operating unit which includes the capability of generating electric energy, and wherein the rotor and stator windings of the electric portion are liquid-cooled in a simple and effective manner.

This object is achieved through an operating unit comprising an internal combustion engine that drives an electric generator, whose rotor and stator are at least partly immersed in a coolant bath.

The liquid, preferably oil, is thus dragged into the air gap defined by the rotor and stator, thereby cooling the windings of both components.

In accordance with a preferred embodiment of the invention, the operating unit is a nautical one and the generator cooling oil exchanges heat with seawater, thus improving the generator cooling effect even further.

These and other features of the invention will become more apparent from the following description pertaining to a preferred but not limiting example of embodiment of the invention as shown in the annexed drawings, wherein:

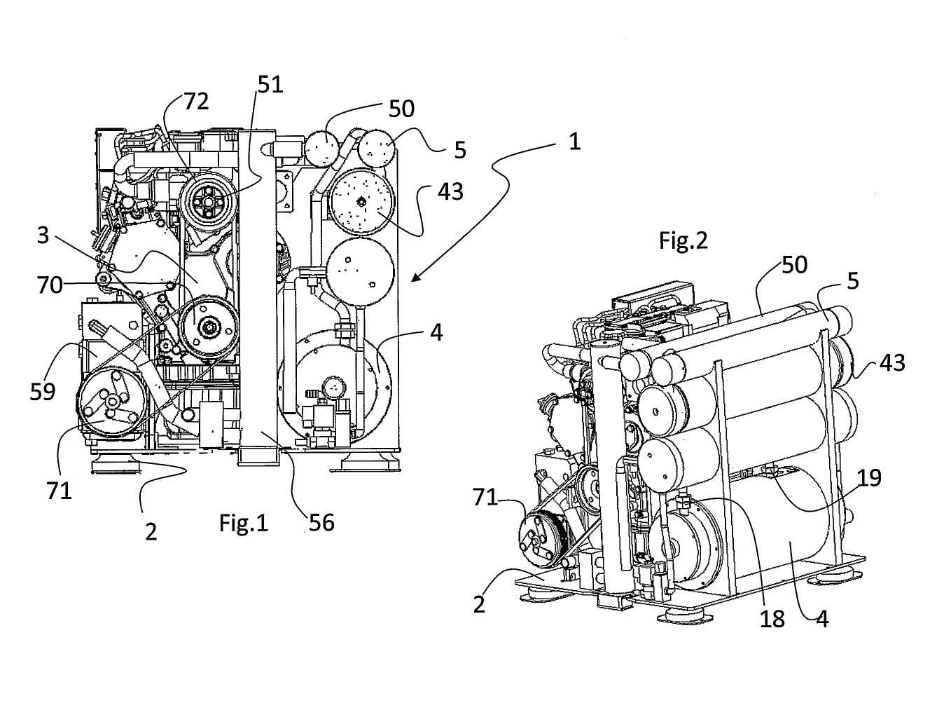

FIG. 1 is a side view of an operating unit according to the invention;

FIG. 2 is a perspective view of the operating unit of FIG. 1 from the same side;

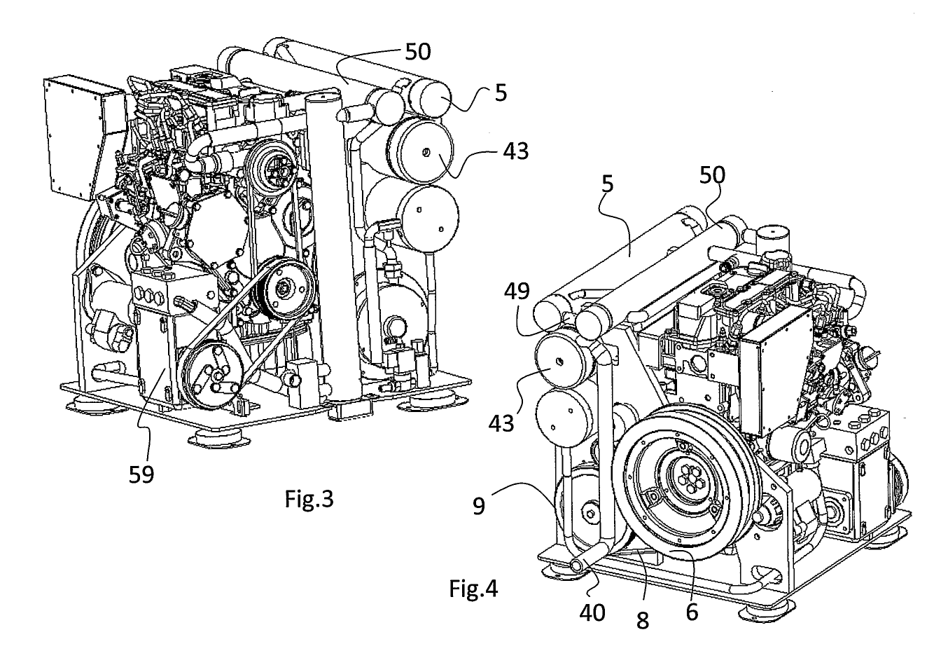

FIG. 3 is a perspective view of the preceding operating unit from a different angle than FIG. 2;

FIG. 4 is a perspective view of the operating unit of FIG. 1 from the opposite side;

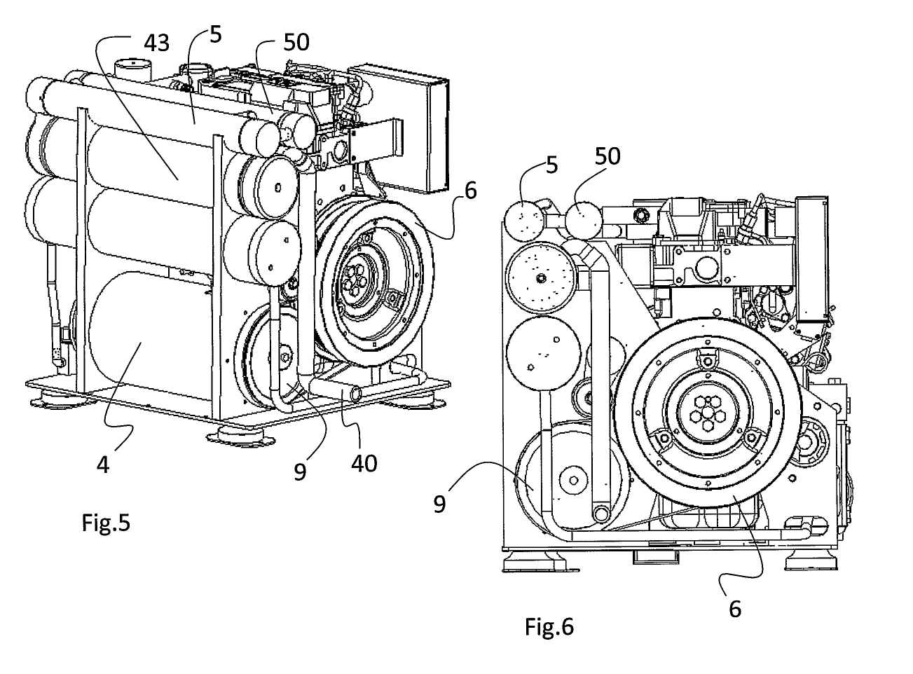

FIG. 5 is a perspective view of the preceding operating unit from a different angle than FIG. 4;

FIG. 6 is a side view of the preceding unit from the same side as FIG. 4;

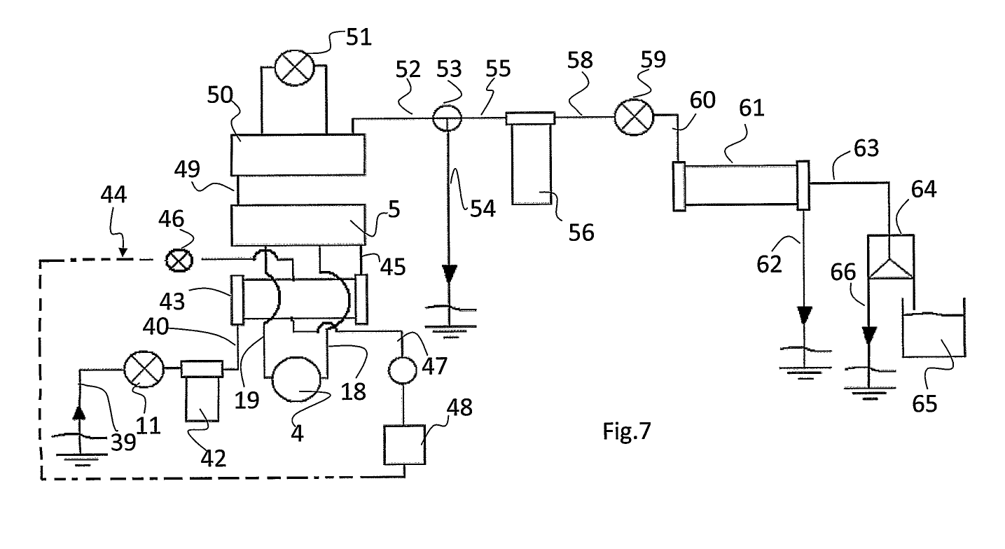

FIG. 7 is a diagram that illustrates the operation of the operating unit of FIG. 1;

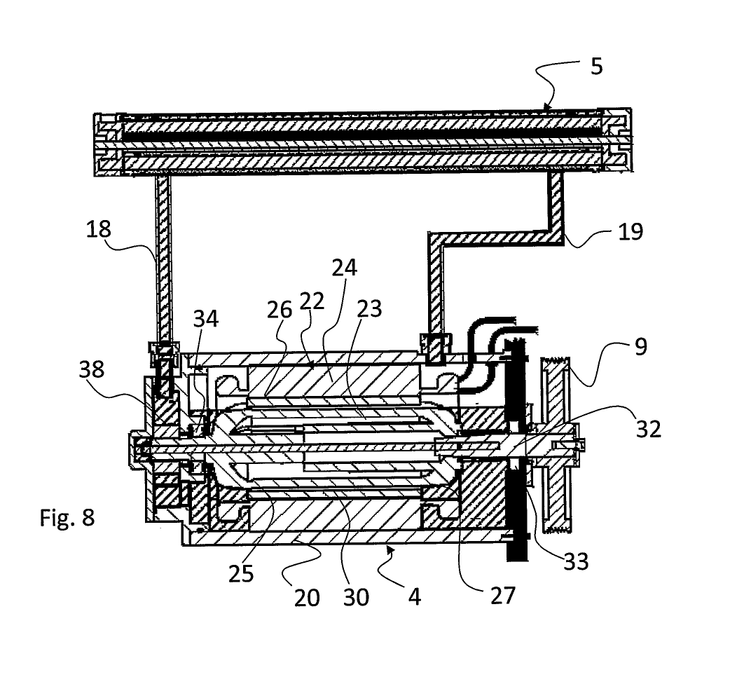

FIG. 8 is a longitudinal sectional view of the alternator and water-oil heat exchanger of the operating unit;

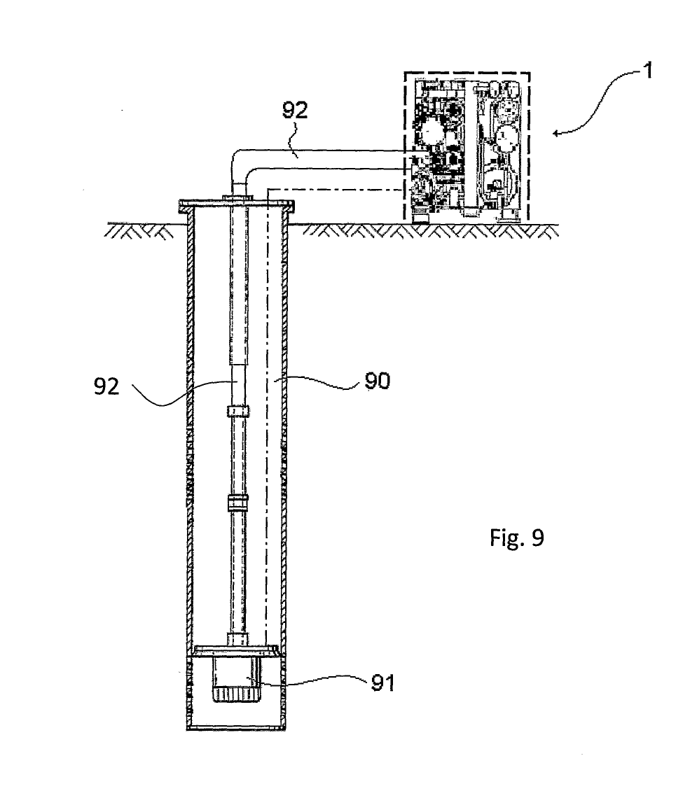

FIG. 9 shows a variant embodiment of the unit according to the invention.

Referring now to FIG. 1, reference numeral 1 designates as a whole an operating unit according to the invention, intended for producing electric energy for nautical applications.

Said unit is mounted on a base 2 and comprises an internal combustion engine 3, preferably a diesel engine, that drives an electric generator 4; a heat exchanger 5 is also installed on the same base 2 for cooling the alternator, which will be described in detail later on.

The same base 2 houses other parts of operating unit 1 as well; however, this description will initially only focus on the type and operation of alternator 4 driven by engine 3 and cooled by means of exchanger 5.

Electric generator 4 may be of a type that produces either alternating or direct current, and therefore, although reference will be made hereafter mainly to an alternator (which generates alternating current), the term “generator” used in the following claims shall be understood broadly as including both possibilities.

Combustion engine 3 drives alternator 4 through a drive pulley 6 arranged on the alternator shaft, as shown in more detail in FIGS. 4, 5 and 6.

In accordance with this embodiment of the invention, alternator 4 is cooled by an oil bath, the oil being circulated in a circuit by an impeller 38 mounted to the end of the alternator opposite to drive pulley 6; the cooling oil is of the type employed in electric applications (e.g. for transformer cooling), and the oil circulation circuit exchanger 5 and ducts 18 and 19.

For this purpose, alternator 4 is connected to exchanger 5 by means of two ducts, i.e. a first delivery duct 18 fed by oil moved by the impeller, and a second return duct 19 extending upwards at a preset height from the bottom of alternator armature 20: thus, in the lower portion of armature 20 oil accumulates in which stator 22 and rotor 23 are partially immersed.

The latter are of a per se known type and are each provided with respective windings 24 and 25, with polar expansions 26 and 27, in addition to the air gap defined therebetween; the stator winding is connected to a distribution network and to all those devices typically used for current regulation purposes (voltage and phase regulators, rectifiers, etc.) in electric systems supplied by known generators.

In this case, it should just be pointed out that stator winding 24 is the induced one and is a star-connected three-phase winding, but it may also be a single-phase or two-phase winding.

As will become more apparent from the description of the operation of unit 1, alternator 4 is preferably of the rotary field type, which rotary field is generated by excitation winding 25 of rotor 23, which is fitted to a shaft 32 supported in armature 20 by two bearings 33, 34; at the ends of shaft 32 there are pulley 9 on one side and impeller 38 on the opposite side.

As shown in FIGS. 5, 6 and 8, internal combustion engine 3 turns alternator 4 through drive belt 8 and pulley 9, thus producing electric energy just like common alternators; it should however be pointed out that unit 1 includes means (not shown since they are per se known) for controlling the revolution speed of the alternator.

At the same time, combustion engine 3 also drives pump 11 that circulates water in exchanger 5, by means of a drive belt and pulleys not shown in the drawings.

In this case, the water circulating in exchanger 5 follows the oil current, but it may also be countercurrent; also, exchanger 5 itself may be of the coil type, tube bundle type or any other type suitable for the application.

According to the preferred nautical application of the invention, the water circulating in the exchanger is seawater, or anyway water coming from the outside of the boat in which operating unit 1 is installed.

The spinning motion of alternator shaft 32 drives an impeller 38 which pushes the oil into the circuit formed by duct 18, exchanger 5, duct 19 and alternator 4.

As aforementioned, the oil coming from exchanger 5 accumulates in the lower portion of the alternator; it is therefore colder than the oil exiting the armature through duct 18.

The oil accumulated on the bottom of the armature is dragged along air gap 30 by spinning motion of rotor 23, and from there it is then distributed through the effect of centrifugal force: stator 24 is thus cooled by oil sucked from the armature bottom and brought into air gap 30 without needing specific means such as pumps or the like, and without requiring any modifications to the structure of the alternator.

In fact, the latter comprises a stator 22 and a rotor 23 of a known type, and even the dimensions of air gap 30 are those commonly used as a function of the electromechanic parameters of the system, like rotor diameter, electric currents and power outputs involved, rotor rpm, electric winding phases, connection type, etc.

Preferably, for generators with power outputs below 10 kW and alternating currents with a 50 Hz frequency, the size (at the radius) of the air gap is smaller than 10 mm, thus allowing the oil to be dragged effectively by the spinning motion of the rotor and distributed onto the stator.

Resuming now the description of the whole operating unit 1 shown in the annexed drawings, it is now appropriate to refer to FIG. 7, which is a general diagram that illustrates the operation of said unit: the idea at the basis of the operating unit so conceived is using seawater as a cooling liquid for the various user apparatuses, which in the illustrated case consist of alternator 4, an environmental air conditioning system, and the diesel engine cooling system; after having removed heat from said user apparatuses, the seawater can then be desalinated for on-board use.

In the illustrated example, the alternator oil cooling water is seawater taken in through outboard inlet duct 39, when the operating unit is installed on a boat.

The inlet water is then pumped by pump 11 towards a filter 42, which retains impurities as small as 150 micrometres (μm), and reaches through duct 39 a water-gas exchanger 43 of a refrigerating system 44, e.g. for conditioning the on-board environments of the boat.

The fluid of refrigerating system 44, delivered in gaseous form to exchanger 43 by compressor 46, condenses through the effect of the heat exchange that occurs in exchanger 43 and then flows out through outlet duct 47 to a filter 48, from which it circulates again in refrigerating system 44.

When it arrives at exchanger 43, the temperature of the seawater rises due to the thermal exchange caused by the refrigerating fluid phase change, and then flows out of exchanger 43 into duct 45.

The seawater conveyed by duct 45 then enters the aforementioned water-oil exchanger 5, where it exchanges heat with the cooling oil coming from alternator 4, thus getting warm.

The water flowing out of water-oil exchanger 5 is delivered through duct 49 to water-liquid exchanger 50, where the seawater exchanges heat with the diesel engine cooling liquid, thereby lowering the temperature thereof; the liquid is pumped towards water-liquid exchanger 50 by pump 51.

Downstream of exchanger 50, the seawater enters duct 52 and can alternatively be delivered either to drain 54 through valve 53, which maintains a preset maximum pressure in the system, or to the desalination system, which will be described later on.

Valve 53 is used for keeping the system pressure at a certain level, e.g. 6 bar, above the atmospheric pressure, in order to facilitate the operation of the operating unit; in fact, it prevents the non-desalinated water from being drained at atmospheric pressure.

If valve 53 is closed, the water flows on through duct 55 towards the filter 56, which removes from it any impurities as small as 5 micrometres; from the latter, the water arrives through duct 58 at pump 59, which delivers it through duct 60 to the reverse osmosis desalination system.

From desalination system 61, the concentrate, i.e. the salt-rich wastewater produced by the reverse osmosis desalination process, is discharged into the sea through drain 62, whereas the desalinated water obtained by reverse osmosis is delivered through duct 63 to a three-way valve 64, which alternately supplies the desalinated water to on-board water system 65 or discharges the desalinated water into the sea through drain 6, when not used by the on-board water system.

The parts described with reference to FIG. 7 are also shown in the assembled condition in FIGS. 1 to 6, wherein they are designated by the same reference numerals; therefore, they will not be described any further.

It should however be pointed out that in FIG. 1, on the side of the shaft of diesel engine 3 opposite to pulley 6, there is an additional pulley 70 connected through belts to two driven pulleys 71 and 72 respectively driving pump 59, which delivers water to the desalination system, and pump 51, which delivers the diesel engine cooling liquid to water-liquid exchanger 50.

It is also appropriate to draw attention to the fact that, thanks to the above-described features, the illustrated operating unit is particularly compact, which translates to advantage into less room taken up when installed on a boat, where room is especially critical: as a matter of fact, the unit so manufactured can be easily housed in the space that is usually employed for installing the boat's diesel engine, while however providing additional functions such as power generation, environmental conditioning and water desalination.

From what has been described so far, it can be understood how operating unit 1 according to the invention achieves the object set forth initially.

In the first place, it should be noted that the alternator cooling system is effective, in that the oil used is in turn cooled by water that, as aforementioned, in nautical applications is seawater at an average temperature around 20° C.

This allows alternator 4, and more in general operating unit 1 as a whole, to be kept so compact as to be enclosed in a soundproofing hood.

Secondly, it should be highlighted that alternator 4 has a simple configuration which requires no special head-mounted oil-accumulation chambers or ducts to distribute oil to the various parts of the armature, since this function is accomplished by using the air gap between the rotor and the stator, which is in any case always present.

From this point of view, the invention clearly differs from the U.S. Pat. No. 3,078,409 mentioned in the beginning, wherein the oil is distributed by an axial channel and then follows a long and tortuous path leading to the excitation and induced windings.

Another advantage of the invention is that rotor 23 and stator 22 are cooled simultaneously, in that the former, when it is rotating, passes at every revolution through the oil accumulated on the bottom of the armature and is thus cooled, while at the same time dragging the oil into air gap 30, thereby cooling the stator as well.

Of course, the invention may be subject to many variations with respect to the example taken into consideration so far.

Reference has already been made above to the possible alternatives as to the number and connection type of the stator winding phases; more in general, it can be said that the rotor as well may have a variable number of poles (two, four, etc.), depending on the alternator design choices.

All the possible variants shall in any case include an air gap between the rotor and the stator, in which the cooling oil present on the bottom of the armature and dragged by the spinning motion if the rotor can be distributed.

In connection with the preliminary statements made in the present description, it should be clarified that the principles of the invention not only apply to alternators, but also more in general to any electric machines having a stator and a rotor coupled magnetically by means of an air gap.

Therefore, the alternator may be replaced by a direct current generator (dynamo) or the like, but intermediate solutions may be adopted as well in which, for example, a current rectifying device installed downstream of the alternator provides a direct current output.

Also, the relative positions of the exchangers along the path of the seawater as described with reference to FIG. 7 may be changed, desalination system 61 is optional, and the seawater may be discharged directly into the sea from the outlet of water-liquid exchanger 50.

Of course, the invention is not limited to marine applications; if lake or river freshwater is available, the desalination part of the system may be removed or possibly replaced with different functions.

Finally, it is apparent that the belt and pulley transmissions employed for driving alternator 4 and the pumps may be replaced with other mechanisms (gears, connecting rod-crank mechanisms or the like), and the water and oil pumps may be arranged in different locations, e.g. outside the exchanger.

In this frame, it should also be underlined that the operating unit so conceived is also suitable for terrestrial applications.

In fact, the advantages offered by the invention can be exploited whenever there is water available for exchanging heat with the various parts of the unit as explained above.

This is not only true in the case of rivers or lakes, from which water can be easily supplied possibly by installing the unit on board of boats or floating bases, but also in dry land areas where water can be provided by digging wells into the ground.

This situation is shown diagrammatically in FIG. 9, wherein a unit 1 like the one already described above, which will not therefore be described any further (a dashed line in the drawing represents the shape of the hood that encloses the unit), is installed near a well 90 where there is a pump 91; the latter is in flow communication with unit 1 by means of a duct 92.

Pump 91 is powered by unit 1 (in FIG. 9 the electric connection between pump 91 and unit 1 is indicated schematically with a dashed-dotted line) and is preferably a submersible pump, i.e. suitable for staying immersed in water lying on the well bottom; pumps of this kind are commercially available, e.g. like those manufactured by company ITT Flygt, and can supply water with prevalence values over 10 metres and flow rates up to a few tenths of litres per second.

The electric energy necessary for operating the pump is supplied by generator group 1, whose internal combustion engine 3 and generator deliver adequate power to supply a pump which may require up to 5-10 kW.

All of these variants will still fall within the scope of the following claims.

1. Operating unit comprising an internal combustion engine (3), an electric generator (4) associated with the internal combustion engine for generating electric energy, wherein the generator comprises an armature (20), a stator (22) and a rotor (23) housed in the armature (20) between which an air gap (30) is defined, characterized in that the rotor and the stator are cooled by a liquid contained in the armature, in which they are partly immersed.

2. Operating unit according to claim 1, wherein the spinning motion of the rotor (23) drags the cooling liquid along the air gap (30), thereby also cooling the stator (22).

3. Operating unit according to claim 1, wherein the cooling liquid of the electric generator (4) exchanges heat with, thus being cooled by, another liquid coming from the outside of the unit.

4. Operating unit according to claims 1, comprising a pump (16) for the circulation of the cooling liquid of the electric generator (4), which is driven by transmission means (13, 14, 15) connected to a generator shaft (32).

5. Operating unit according to claim 4, wherein the shaft (32) of the generator (4) is the one to which the rotor (23) is fitted.

6. Operating unit according to claim 3, comprising a pump (11) for the circulation of the liquid coming from the outside of the unit, which is connected to the internal combustion engine (3) through transmission means (6, 7, 10) for its activation.

7. Operating unit according to claim 3, comprising a pump (11) for the circulation of the liquid coming from the outside of the unit, which is supplied with electric energy produced by the generator (4).

8. Operating unit according to claim 3, comprising a heat exchanger (5) in which the generator cooling liquid exchanges heat with the liquid coming from the outside of the unit.

9. Operating unit according to claim 8, wherein the generator armature (20) is in fluid communication with the heat exchanger (5) for circulating the generator cooling liquid to and from it.

10. Operating unit according to claim 1, wherein the rotor (23) of the electric generator (4) is arranged inside the stator (22).

11. Operating unit according to claim 3, further comprising a water-gas exchanger (43) for a refrigerating system (44), wherein a refrigerating gas exchanges heat with the liquid coming from the outside of the unit.

12. Operating unit according to claim 3, further comprising a water liquid exchanger (50) in which a cooling liquid of the internal combustion engine (3) exchanges heat with the liquid coming from the outside of the unit.

13. Operating unit according to claim 12, wherein the cooling liquid of the electric generator (4) is oil.

14. Operating unit according to claim 3, which is intended for nautical use and wherein the liquid coming from the outside is seawater, lake water or the like.

15. Operating unit according to claim 14, further comprising a desalination system (61) of the reverse osmosis type adapted to desalinate said seawater.

16. Operating unit according to claim 15, wherein the path followed by the water coming from the outside comprises, in this order, the water-gas exchanger (43), the water-oil exchanger (5), the water-liquid exchanger (50), the desalination system (61).

17. Operating unit according to claim 1, wherein the electric generator (4) is an alternator.

18. Boat characterized by comprising an operating unit according to any of claims 1 to 17.

19. Electric generator comprising an armature (20), a stator (22) and a rotor (23) housed in the armature (20) between which an air gap (30) is defined, characterized in that the rotor and the stator are cooled by a liquid contained. in the armature, in which they are at least partly immersed.

20. Generator according to claim 19, wherein the spinning motion of the rotor (23) drugs the cooling liquid along the air gap (30), thereby also cooling the stator (22).

21. Generator according to claim 19 or 20, wherein the cooling liquid is oil.
